(19) United States
(12) Patent Application Publication
(10) Pub. No.: US 2024/0077681 A1
(43) Pub. Date: Mar. 7, 2024

(54) ADAPTER BULKHEAD STRUCTURALLY CONFIGURED TO ENHANCE ACCESS TO ADAPTERS ON AN ADAPTER HOLDER

(71) Applicant: PPC BROADBAND, INC., East Syracuse, NY (US)

(72) Inventor: Nicholas LARSSON, Blomkest, MN (US)

(73) Assignee: PPC BROADBAND, INC., East Syracuse, NY (US)

(21) Appl. No.: 18/242,685

(22) Filed: Sep. 6, 2023

Related U.S. Application Data
(60) Provisional application No. 63/374,659, filed on Sep. 6, 2022.
(60) Provisional application No. 63/462,686, filed on Apr. 28, 2023.

(51) Int. Cl. G02B 6/36

(52) U.S. Cl. CPC G02B 6/3616

(57) ABSTRACT

An adapter bulkhead apparatus may include an adapter holder portion structurally configured to hold an adapter, a retaining portion structurally configured to movingly retain the adapter holder portion. The adapter holder portion may include an adapter receiving portion structurally configured to receive an adapter. The adapter holder portion may include a plurality of adapter holders that are structurally configured to slide relative to one another and relative to the retaining portion so as to enhance access space to the adapter held by the adapter holder portion.

### CROSS REFERENCE TO RELATED APPLICATION

This application claims the benefit of U.S. Provisional Applications No. 63/374,659 filed Sep. 6, 2022, and No. 63/462,686 filed Apr. 28, 2023, both pending, the disclosures of which are hereby incorporated by reference herein in their entirety.

### TECHNICAL FIELD

The present disclosure relates generally to an adapter bulkhead with adapter panels structurally configured to provide enhanced access to adapters, for installing, uninstalling, reconfiguring, cleaning, servicing, etc. connectors and cables on the panels.

### BACKGROUND

As the demand for telecommunications increases, fiber optic networks are being extended in more and more areas. Conventionally, fiber optic enclosures are used to provide a subscriber access point to the fiber optic network. Such a fiber optic enclosure is connected to the fiber optic network through a subscriber cable connected to a network hub.

In many situations, the design of fiber optic enclosures is limited to a maximum size that presents space constraints that limit the amount of room in the box with which a technician has to work. Such space constraints make situations difficult for the technician when installing connectors, cleaning adapter ports, or working with the fiber management.

It may be desirable to provide a telecommunications box, or fiber box, with a small footprint and volume that provides ample working room for a technician. For example, it may be desirable to provide a box having an adapter holder that includes panels configured for increasing or enhancing access space relative to adapters on one of the slidable panels.

### SUMMARY

In one embodiment of the present disclosure, an adapter bulkhead apparatus may include an adapter holder portion structurally configured to hold an adapter, a retaining portion structurally configured to movingly retain the adapter holder portion, and a guide portion structurally configured to guide movement of the retaining portion. The guide portion may be structurally configured to include a movement guide portion structurally configured to permit linear movement of the retaining portion relative to the guide portion from a first position to a second position. The guide portion may be structurally configured to include a pivoting guide portion structurally configured to permit the retaining portion to pivot relative to the guide portion at the second position. The adapter holder portion may include a plurality of adapter holders that are structurally configured to slide relative to one another and relative to the retaining portion so as to enhance access space to the adapter held by the adapter holder portion. The retaining portion may be configured to move relative to the guide portion so as to enhance access space to the adapter held by the adapter holder portion.

In some embodiments, an adapter bulkhead apparatus may include an adapter holder portion structurally configured to hold an adapter, a retaining portion structurally configured to movingly retain the adapter holder portion, and a guide portion structurally configured to guide movement of the retaining portion. The guide portion may be structurally configured to include a movement guide portion structurally configured to permit linear movement of the retaining portion relative to the guide portion from a first position to a second position. The adapter holder portion may include a plurality of adapter holders that are structurally configured to slide relative to one another and relative to the retaining portion so as to enhance access space to the adapter held by the adapter holder portion. The retaining portion may be configured to move relative to the guide portion so as to enhance access space to the adapter held by the adapter holder portion.

In some embodiments, an adapter bulkhead apparatus may include an adapter holder portion structurally configured to hold an adapter, a retaining portion structurally configured to movingly retain the adapter holder portion. The adapter holder portion may include an adapter receiving portion structurally configured to receive an adapter. The adapter holder portion may include a plurality of adapter holders that are structurally configured to slide relative to one another and relative to the retaining portion so as to enhance access space to the adapter held by the adapter holder portion.

### BRIEF DESCRIPTION OF THE DRAWINGS

Further advantages and features of the present disclosure will become apparent from the following description and the accompanying drawings, to which reference is made. In which are shown:

FIG. 1 illustrates a first isometric view of an example adapter bulkhead apparatus according to the present disclosure.

FIG. 2 illustrates a second isometric view of the example adapter bulkhead apparatus.

FIG. 3 illustrates an isometric view of another example adapter bulkhead apparatus wherein each panel defines one opening.

FIG. 4 illustrates an isometric view of the example adapter bulkhead apparatus of FIG. 2 wherein adapters are disposed in each opening.

FIG. 5A illustrates the adapter bulkhead apparatus of FIG. 2 and an example enclosure where the frame (and its panels) of the adapter bulkhead apparatus is in the deployed position.

FIG. 5B illustrates the adapter bulkhead apparatus and enclosure of FIG. 5A where the frame (and its panels) of the adapter bulkhead apparatus is in the stowed position.

FIG. 6 illustrates an enlarged isometric view of the deployable adapter bulkhead apparatus in FIG. 5A.

FIG. 7 illustrates the deployable adapter bulkhead apparatus of the present disclosure wherein the deployable adapter bulkhead apparatus is disposed in a rack mount panel.

FIG. 8 illustrates a perspective view of an enclosure with an adapter bulkhead apparatus in accordance with various aspects of the disclosure.

FIG. 9 illustrates a perspective view of the brackets (guide portion).

FIG. 10 illustrates a perspective view of an adapter bulkhead.

FIG. 11 illustrates a perspective view of an adapter bulkhead and brackets, with the adapter bulkhead in an extended position and with a cleaning tool in place.

FIG. 12 illustrates a perspective view of an adapter bulkhead in a tilted position.

FIG. 13 illustrates a perspective view of an adapter bulkhead.

### DETAILED DESCRIPTION

Reference will now be made in detail to presently preferred compositions, embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

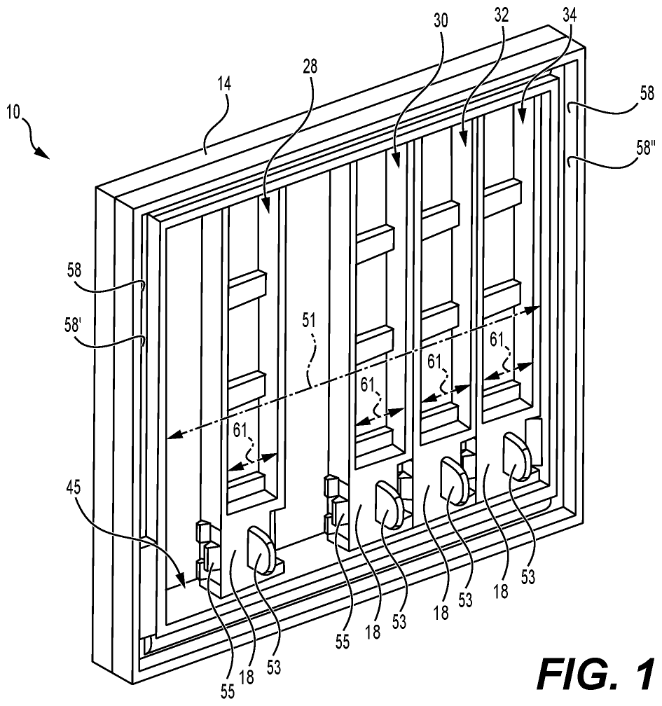

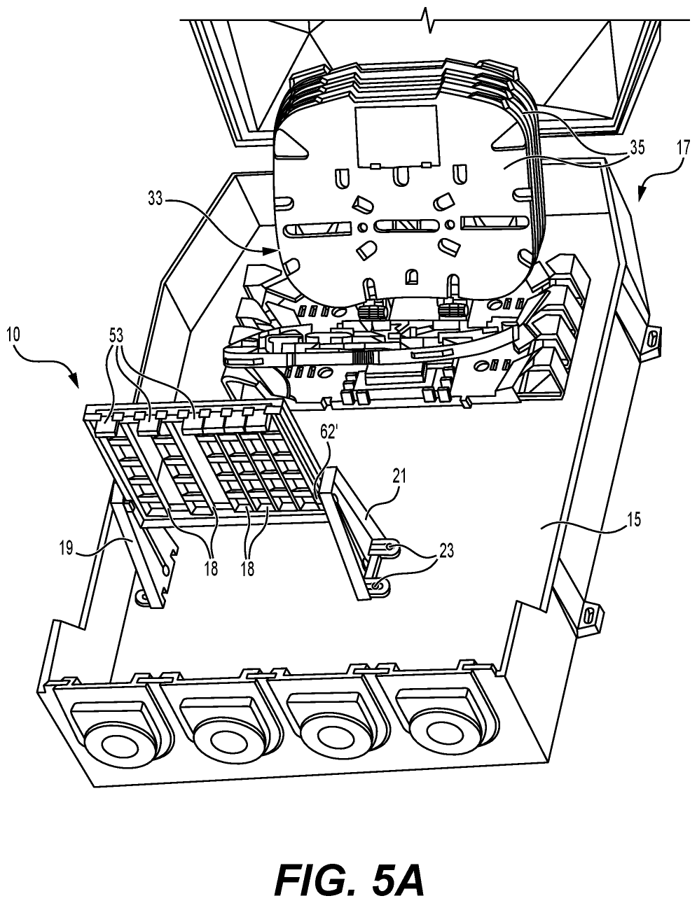

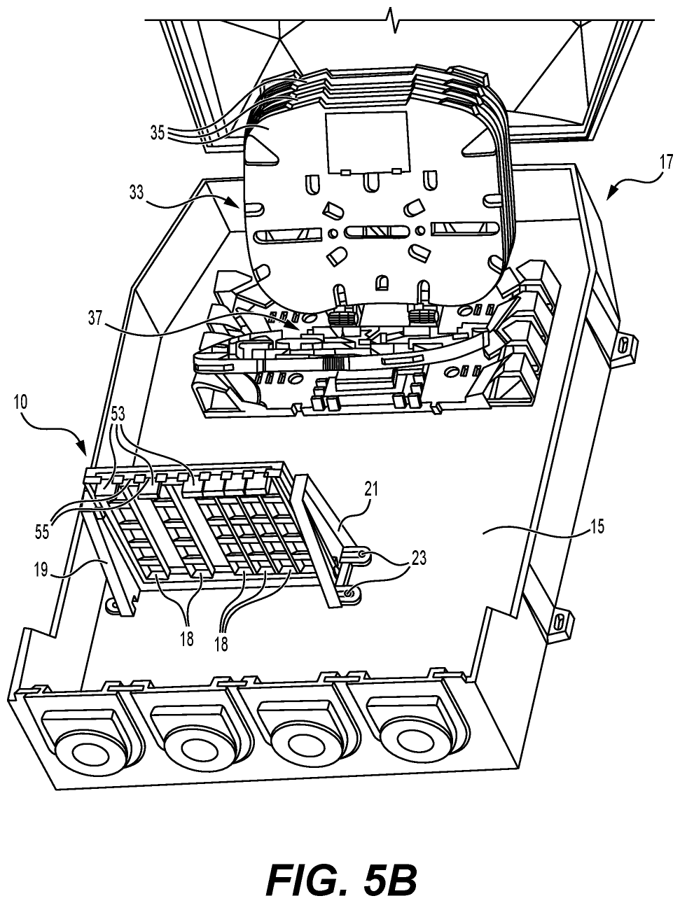

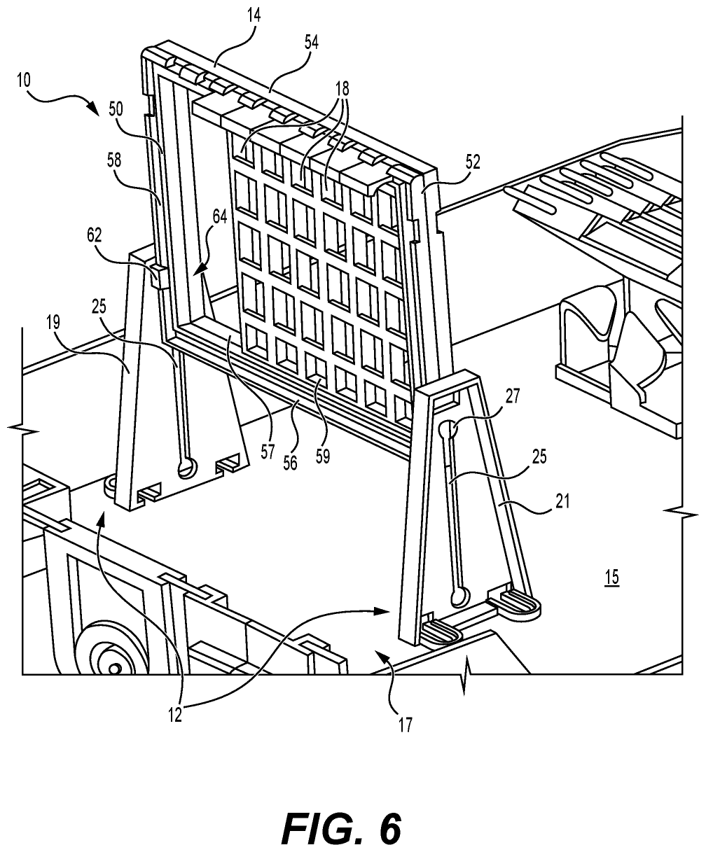

Referring to FIGS. 1-6, an exemplary adapter bulkhead 10 according to the present disclosure includes a base or guide portion 12 (see FIG. 6), a frame or retaining portion 14, and one or more panels or adapter holder portions 18 configured to be slidingly coupled with the frame 14. In some embodiments, the adapter bulkhead 10 may be structurally configured to be disposed within an enclosure 17, as shown in FIGS. 5A and 5B. The panels 18 may comprise adapter panels configured to receive adapters 20 that are configured to couple fiber optic connectors (or other connectors), such as, for example, SC connectors.

The base or guide portion 12 may include a first base or guide member 19 and a second base or guide member 21 spaced apart from one another. In some embodiments, the first and second base members 19, 21 may be integral with the base wall 15 of the enclosure 17. In other embodiments, such as shown in FIGS. 5A-5B and FIG. 6, the first base member 19 and second base member 21 of the base portion 12 may each be separate structures that may be coupled with the base wall 15 of the enclosure 17, for example, using mechanical fasteners 23 or by other means. The first base member 19 and the second base member 21 of the base portion 12 may each define a movement retaining portion 25, such as, for example, a channel, groove, or slot, structurally configured to receive an engagement structure 27, such as, for example, a protrusion, tab, or the like, extending from each side of the frame 14. (See FIG. 6).

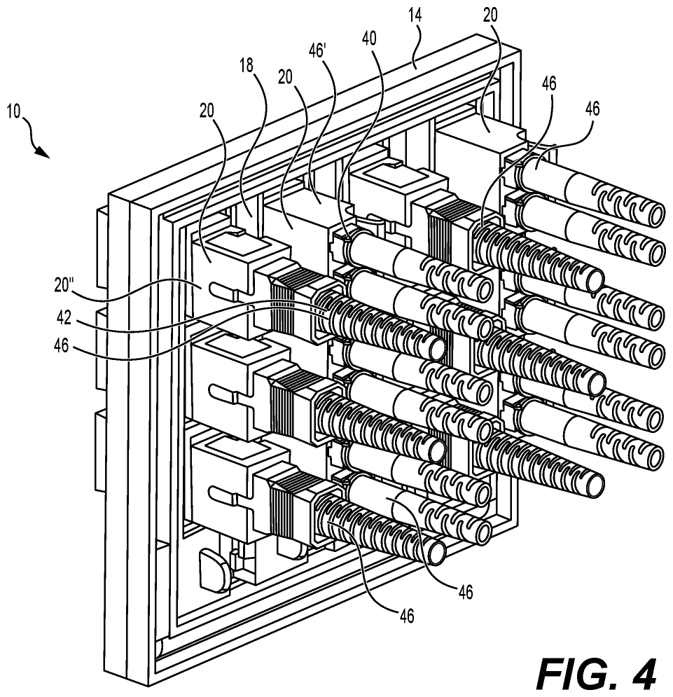

With reference to FIGS. 5A-5B and FIG. 6, the frame 14 is configured such that a technician may move the frame 14 away from the base wall 15 of the enclosure 17 to a deployed or second position, for example, by sliding the frame 14 relative to the base members 19, 21 to increase and enhance the access space for installing the adapters 20 and/or for installing connectors 46 (FIG. 4) into the adapters 20. In the deployed position of the frame 14, the technician will have ample space surrounding the frame 14 such that the technician no longer has to squeeze his or her fingers into the tight spaces within the enclosure 17 as he or she inserts connectors 46 (FIG. 4) into the adapters 20.

In order to increase or enhance the access space for installing the adapters 20 with the panels 18 and/or for installing connectors 46 (FIG. 4) with the adapters 20, the technician may selectively slide one or more of the panels 18 disposed in the frame 14 (FIG. 4). As shown in FIGS. 1-4, the frame 14 defines an opening configured to receive the panels 18. The width 51 of the opening 45 is greater than the total width (or sum of widths 61) of all panels 18 such that each panel 18 is able to slide in the opening of the frame 14 such that a user or a technician may manipulate the location of each panel 18 within the opening 45 of the frame 14 such that the locations or positions for the adapters 120 and/or connectors 46 may be customized (or moved along with width 51 of the opening 45) according to the user's or technician's preferences or needs.

For example, with reference to FIG. 1, when a technician wants to have a first panel 28 with additional space on each side of the first panel 28 for installing adapters and/or connectors, the technician can slide the second, third, and fourth panels to one side of the frame and slide the first panel away from the second panel such that there is space on both sides of the first panel. The first, second, third, and fourth panels 18, 28, 30, 32, 34 may be fixed in their positions shown in FIG. 1 by engaging each locking tab 53 to secure each panel 18 into its position within the frame 14. However, it is also understood that the first panel 28 in FIG. 1 may freely slide within the frame while the second, third and fourth panels 30, 32, 34 are fixed within the frame. In this arrangement, the first panel 28 in FIG. 1 may not be locked into place (by not engaging the locking portion or tab 53) such that the first panel 28 in FIG. 1 may have some flexibility to slide to the left and/or right while the second, third and fourth panels 18, 30, 32, 34 remain in fixed in place.

In another example, the first panel 28 may freely slide within the frame 14 while the second, third and fourth panels 30, 32, 34 are configured to be connected to each other as shown in FIG. 1 yet also slide within the frame 14 as well. Each tab 53 may also be configured to actuate a locking member (not shown) that engages with an upper member 71 or lower member 73 of the frame 14. Thus, all panels 18 shown in FIG. 1 may not be locked into place such that all adapters 20 and connectors 46 (FIG. 4) that are mounted in the frame 14 may have the flexibility to move to the left and/or right within the frame 14. It is understood that any number of panels 18 (including no panels) may be unlocked or locked to suit a particular need.

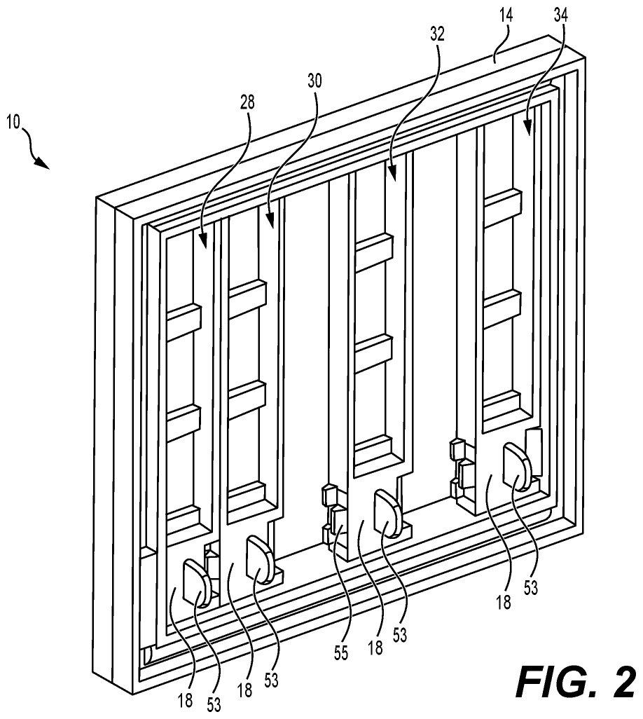

With reference to FIG. 2, the technician may want to have the first and second panels 18, 28 positioned close to each other yet have additional space on each side of third panel 32 as well as have additional space on each side of the fourth panel 34. In one example, the third panel 32 in FIG. 2 may not be locked into place (by not engaging the locking tab 53) such that the third panel 32 in FIG. 2 may have some flexibility slide to the left and/or right—while the first, second, and fourth panels 18, 28, 30, 32 remain in fixed in place within frame 14. However, in yet another example, the first, second, third, and fourth panels 18, 28, 30, 32, 34 may each be fixed in their positions within the frame 14 shown in FIG. 2 by engaging each locking tab 53 to secure each panel 18 into its position within the frame 14. In yet another example, the first and second panels 28, 30 may be connected to each other yet slide within the frame; the third and fourth panels 32, 34 may also be connected to each other yet slide within the frame 14 while the third panel 32 may be fixed within the frame 14. The tab 53 may also be configured to actuate a locking member (not shown) that engages with an upper member 71 or lower member 73 of the frame 14.

With reference to FIG. 6, the frame 14 may include a first lateral side 50, a second lateral side 52, a top side 54 and a bottom side 56 wherein each slidable panel 18 may be inset within the frame 14. As shown in FIGS. 1, 3 and 6, at least two sides of the frame 14 may each define a front channel 58 and a back channel 60 (totaling at least four channels in frame 14). For example, a first tab or first flange 62 from the first base member 19 may be disposed in a front first channel 58′ and a second tab or second flange 64 from the first base member 19 may be disposed in a back first channel 60′. Similarly, a first tab or first flange 62′ from the second base member 21 may be disposed in a front second channel 58″ and a second tab or second flange 64′ from the second base member 21 may be disposed in a back second channel 60″. Once each tab or flange 62, 62′, 64, 64′ is disposed in its corresponding channel 58, 60, the frame 14 (with the sliding panels 18 disposed within the frame 14) may slide into each of the first and second channels 58, 60 in order to install the deployable adapter bulkhead 10 into the enclosure 17. Each sliding panel 18 defines at least one adapter opening 16 that extends through the sliding panel 18 (or the adapter bulkhead 10).

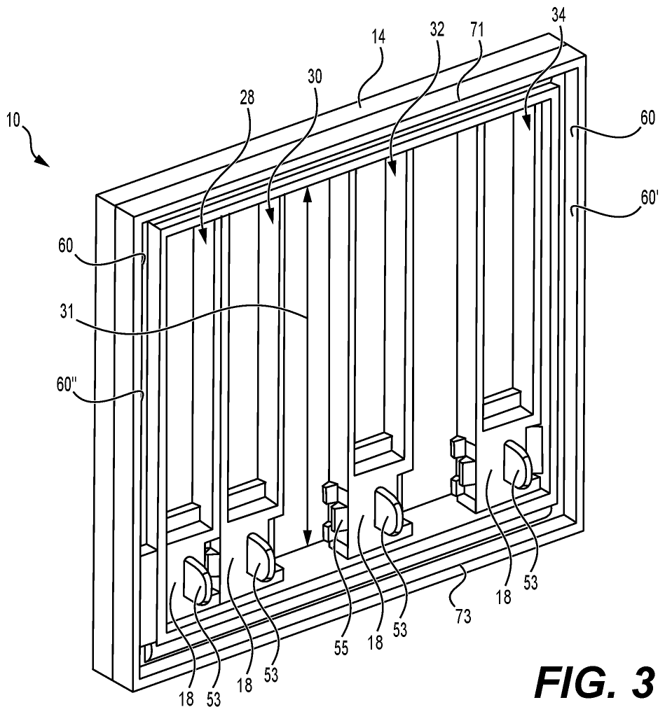

Referring to the embodiments shown in FIG. 1 and FIG. 3, the locking tab 53 may actuate a locking member 55 such that the locking member 55 engages a recess (not shown) in an adjacent panel 18 or in the frame 14 in order to fix a panel's position within the frame 14. With reference to the embodiment shown in FIG. 5B, the locking tab 53 may move between a first down position and a second up position wherein the locking tab 53 engages with a recess/groove/slot 55 defined in the frame 14 in order to fix a panel's position within the frame 14. With respect to the various embodiments of the present disclosure, it is understood that a portion of a bottom edge 59 of each panel 18 may be disposed within a lower groove 57 defined by the frame 14 in order to enable each panel 18 to slide within the frame 14. (See FIG. 6).

In one aspect of the present disclosure, each adapter opening 16 in each panel may be structurally configured to receive at least one fiber optic adapter 20. In the depicted embodiment of FIGS. 1 and 4, each slidable panel 18 defines a plurality of adapter openings 16 wherein each adapter opening 16 is configured to receive an adapter 20. However, as shown in FIG. 3, it is understood that each panel 18 may alternatively only define one adapter opening 16 wherein each adapter opening 18 may be configured to receive a plurality of adapters 20. In the example shown in FIG. 3, each adapter opening 16 may extend a majority of a height H 31 of each slidable panel 18 in the adapter bulkhead 10. However, in the example shown in FIGS. 1 and 4, where adapter openings 18 are defined in each slidable panel 18, each adapter opening 16 only extends across a portion of the height H of each slidable panel 18.

Referring back to the example of FIGS. 1 and 4, the adapter 20 may be a dual LC adapter 46′. The adapter 18 may be secured to the adapter bulkhead 10 by any conventional coupling mechanism. In an embodiment that includes dual LC adapters 46′, each dual LC adapter 46′ is configured to receive a dual LC connector 40 or two single LC connectors 40′. As shown, the SC adapters 20″ are configured to receive an SC connector 42. Regardless, each adapter 20 may be configured to receive a pair of connectors 46 as shown in FIG. 4. The adapter bulkhead 10 is configured to house a plurality of adapters 20 that are configured to optically couple fiber output cables 47 to connectorized ends of one or more distribution cables 49 (See FIG. 4).

Referring now to FIGS. 5A-5B, the adapter bulkhead 10 may be disposed in an enclosure proximate to a tray stack 33 as shown. The tray stack 33 may include a plurality of trays 33 mounted to the mounting portion 35 of the enclosure.

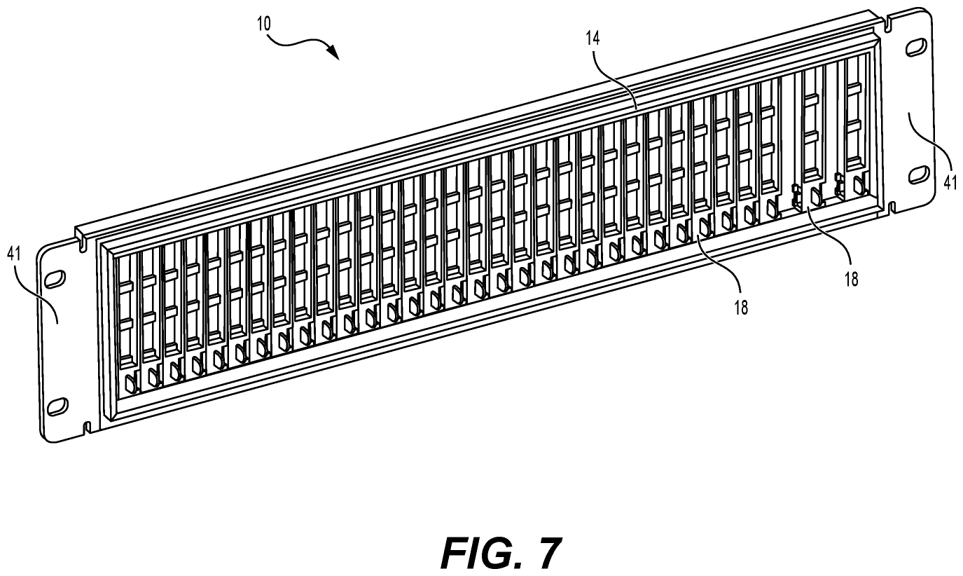

With reference to the additional embodiment shown in FIG. 7, it is also understood that the adapter bulkhead apparatus 10 of the present disclosure may be modified as shown in FIG. 7 such that the frame and bulkhead may be disposed in a U-space rack (not shown). A mounting bracket 41 may be on a first end and a second end of the U-space rack so that the bulkhead 10 may be mounted to the U-space rack.

Referring now to FIG. 6, an adapter bulkhead apparatus 10 provides enhanced access to an adapter 20. The adapter bulkhead apparatus 10 includes a base portion 12, a frame 14, a plurality of panels 18. The base portion 12 may be configured to include a first base member 19 and a second base member 21. The frame 14 may be configured to move between a first position and a second position. The panels 18 may be configured to be slidingly coupled in an opening 45 in the frame 14. Each panel 18 of the plurality of panels may include at least one adapter opening 16 configured to receive an adapter 20. Each panel 18 of the plurality of panels may be configured to include a locking tab 53 structurally configured to lock each panel 18 in position relative to the frame 14. The frame 14 may defines a first pair of channels 58, 60 at a first lateral side 50 and a second pair of channels 58, 60 at a second lateral side 52 such that each channel is configured to receive a tab 62, 62′, 64, 64′ defined by the base portion 12. The first base member 19 is configured to define a first slot 25 and the second base member 21 is configured to define a second slot 25. A portion 27 of the first lateral side 50 of the frame 14 is configured to slide within the first slot and a portion 27 of the second lateral side 52 of the frame 14 is configured to slide within the second slot 25 such that the second deployed position of the frame 14 provides enhanced access to the plurality of adapters 120. The panels 18 are configured to slide within the frame 14 to increase access space relative to adapters 20 on a selected one of the panels 18.

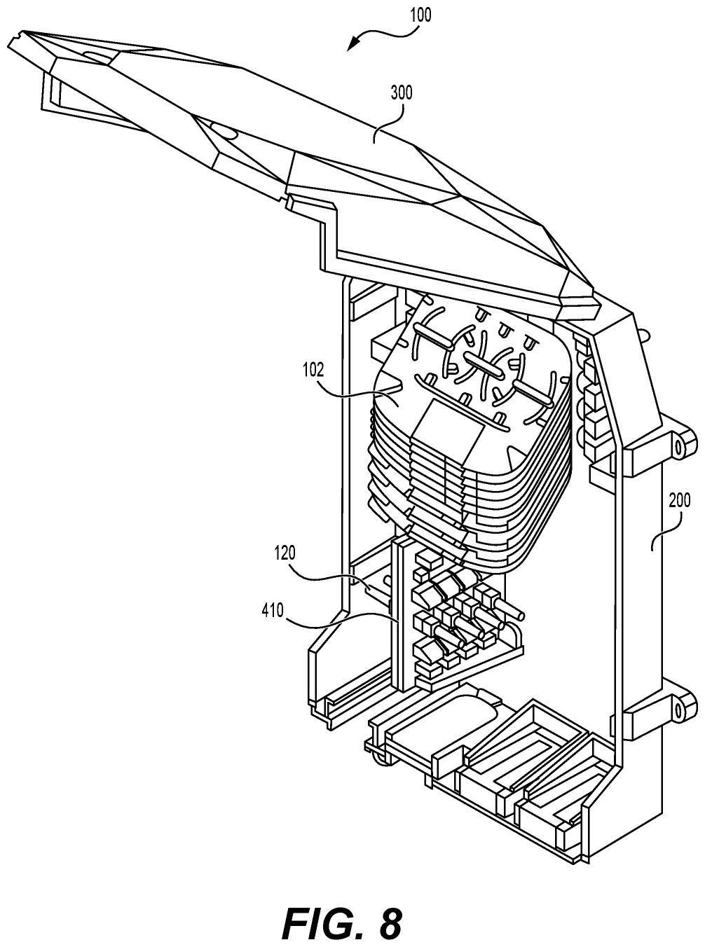

FIG. 8 shows an exemplary enclosure 100 in accordance with embodiments of the disclosure. The enclosure 100 has, in this example, a base 200 and a cover 300. In this example, the cover 300 is attached to the base 200 by a hinge 228. In other examples, the cover 300 is attached to the base 200 by a friction fit or other mechanism. The enclosure 100 has holds a plurality of splice tray, and/or other trays, 102 that are used to organize and maintain spliced, or other, fiber optic cables.

In this example, the enclosure 100 has one or more bulkhead assemblies having an adapter bulkhead 410. The bulkhead 410 is configured to receive one or more adapters 120. In embodiments, each of the adapters 120 is configured to receive a connector 40 on each side of the bulkhead 410. In embodiments, each of the connectors 40 on one side of the bulkhead 410 is attached to an entering cable, such as, for example, a fiber optic cable, (not shown) that enters the enclosure 100 through one of the ports in a bottom wall of the enclosure 100. In embodiments, each of the connectors is attached on its opposite side to a fiber optic cable such as, for example a pigtail, that leads to one of the trays 102. The adapter bulkhead 410 is movable to other positions, such as, for example, a first extended position, a second extended position, and a tilted position, to provide better access to the adapters 30 and the connectors 40.

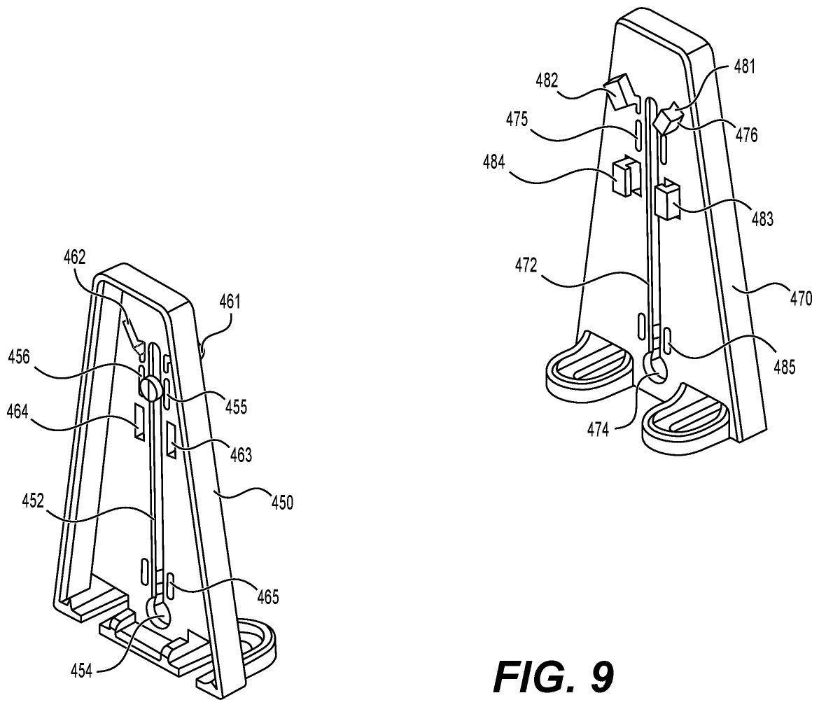

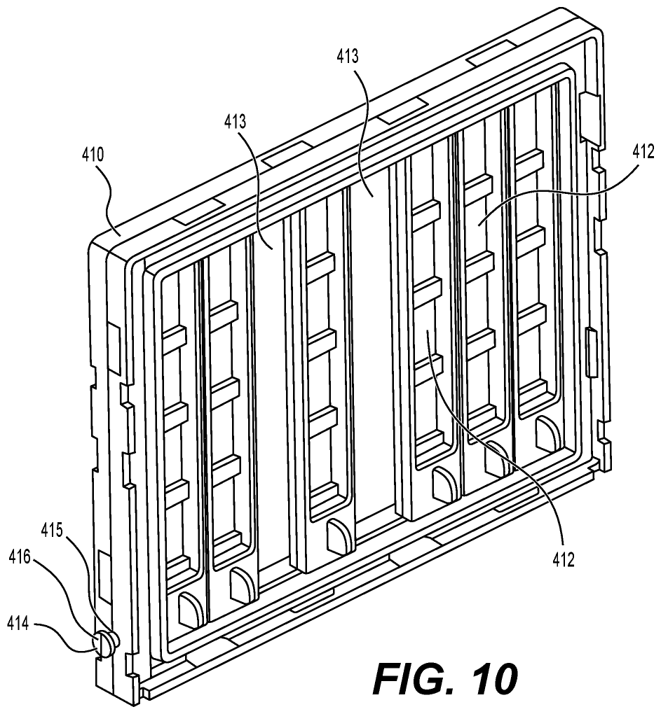

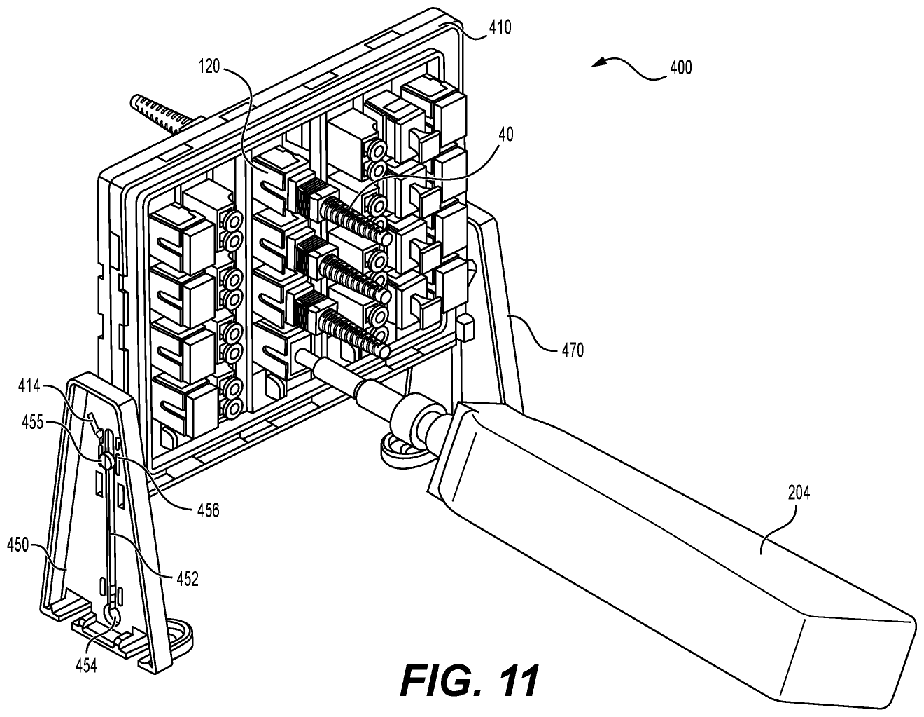

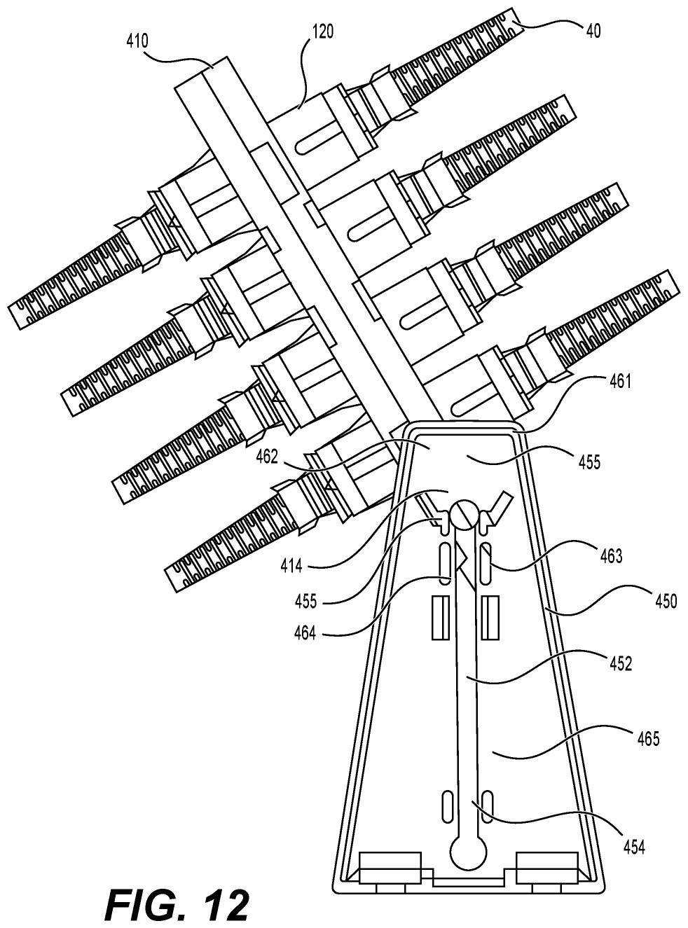

FIGS. 11 and 12 show the adapter bulkhead assembly 400 including the bulkhead 410 and the mounting brackets 450, 470. In FIGS. 11 and 12, the adapter bulkhead is in a second extended position. A protrusion 414 on each side of the bulkhead 410 engages a slot 452 in the mounting bracket 450 and a slot 472 in the mounting bracket 470. In embodiments, each protrusion 414 has two cylindrical portions 415, 416. In embodiments, these cylindrical portions include a shaft 415 and a head 416, as shown in FIG. 10. The head 416 is a larger diameter sized to fit through assembly openings 454, 474 in mounting brackets 450, 470, but be retained by the slots 452, 472, as shown in FIG. 9. Assembly openings 454, 474 are positioned so the bulkhead 410 can be inserted into the mounting brackets 450, 470 when free, but when the mounting brackets 450, 470 are mounted to a surface (such as, for example, base wall 15, FIG. 6), that surface prevents the bulkhead 410 from traveling toward the surface far enough to align with the assembly openings 454, 474, therefore preventing separation of the bulkhead 410 from the mounting brackets 450, 470. As the bulkhead is moved from the stowed position to the first extended position, the protrusions 414 move from lower retention features 465, 485 to first extended retention features 455, 475. In this example, the lower retention features 465, 485 and the first extended retention features 455, 475 are detents that hold the bulkhead 410 in the respective positions. Other embodiments include additional retention features at intermediate points on one or both of the mounting brackets 450, 470 to provide intermediate positions of the bulkhead 410.

Embodiments include a tilting feature of the adapter bulkhead 410 to allow access to the adapters 120 and the connectors 40 that cannot be accessed (or easily accessed) with the adapter bulkhead 410 in the first position. FIG. 11 shows a second extended retention feature 456 in the slot 452 which is positioned above the first extended retention feature 455 and at the end of the slot 452. FIG. 12 also shows tilting stops 461, 462 on the mounting bracket 450 which contact the bulkhead 410 and limit the extent to which the bulkhead can tilt. In embodiments, the mounting bracket 470 includes tilting stops 481, 482 which contact the bulkhead 410 and limit the extent to which the bulkhead can tilt. In embodiments, the tilting stops 461, 462, 481, 482 are configured to stop the bulkhead at a tilt of 30 degrees in both directions. In other embodiments, the tilting stops 461, 462, 481, 482 are configured to stop the bulkhead at a tilt of other than 30 degrees in one or both directions. In other embodiments, the tilting stops 461, 462, 481, 482 are configured to stop the bulkhead at a tilt of one angle in one direction and a different angle in the other direction. The angle of tilt to which the bulkhead is limited can be configured to correspond to the obstructions anticipated and/or the size and/or shape of the adapters 30 and connectors 40 used.

FIGS. 11 and 12 show the bulkhead adapter 410 in a tilted position. The tilted position provides more room for the tool 204 to clear the side wall of the base 200 (FIG. 8) and other obstructions that may be present. These other obstructions can include other bulkhead assemblies and/or other devices in the base 200 as well as obstructions outside of the enclosure 100 such as, for example, other enclosures or adjacent walls.

The protrusions 414 of the bulkhead 410 engage the second extended retention feature 456 in the mounting bracket 450 and the second extended retention feature 476 in the mounting bracket 470. As the bulkhead is moved from the first extended position to the second extended position, the protrusions 414 move from first extended retention features 455, 475 to second extended retention features 456, 476. In this example, the second extended retention features 456, 476 are trapezoidal-shaped detents (although other shapes could be used) that match the shape of the protrusions 414 on the bulkhead 410 to facilitate rotation of the protrusions 414 in the second extended retention features 456, 476 to enable titling of the bulkhead 410. A side of the bulkhead 410 rests against the tilting stops 462, 482 to limit the degree of tilt of the bulkhead 410. The bulkhead can also be tilted in the direction opposite to that shown in FIG. 12 to provide access to the opposite side of the bulkhead 410. When tilted in the opposite direction, the bulkhead is stopped by the tilting stops 461, 481 on the mounting brackets 450, 470. The titling stops 462, 482 (and 461, 481) also provide support for the bulkhead 410 to resist force exerted by a user on the bulkhead 410 when in the tilted position.

The mounting brackets 450, 470 are illustrated without the adapter bulkhead in FIG. 9 to show the various features of the mounting brackets 450, 470. FIG. 10 shows the bulkhead 410 having a number of openings 412 that are configured to receive and retain the adapters 120. In embodiments, various other openings 413 are provided to allow a technician to selectively position the adapter holders creating space for their fingers and tools or for other reasons.

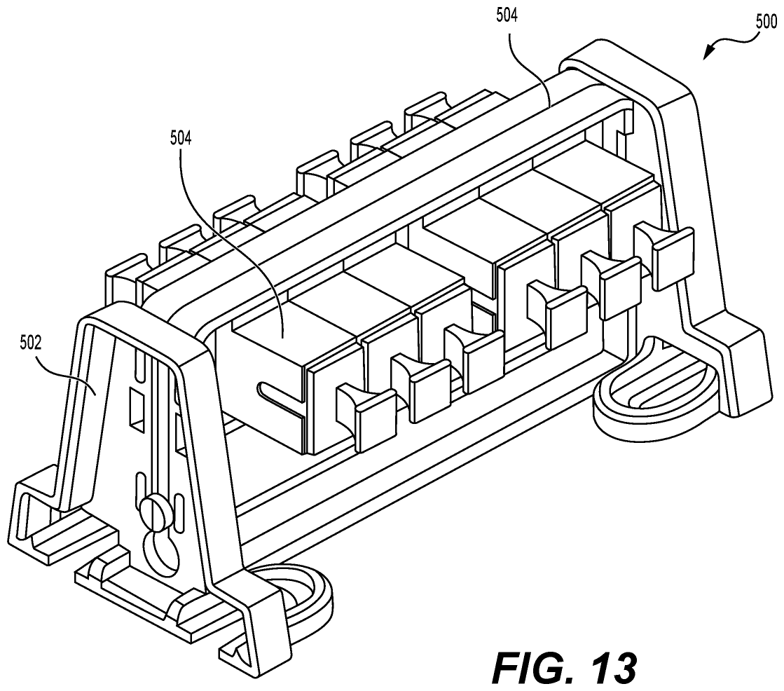

FIG. 13 illustrates an adapter bulkhead apparatus 500 in accordance with various embodiments. The adapter bulkhead apparatus 500 may include a guide portion 502 with an adapter bulkhead 504 configured to receive adapters 506. This embodiment may include the features of the guide portion 502 allowing the sliding and tilting of the adapter bulkhead 500 as described in conjunction with the other embodiments. However, in this embodiment, the adapters 506 are not configured to move within the adapter bulkhead 504, but the adapter bulkhead 504 is configured to move within the guide portion 502 to provide enhanced access to the adapters 506.

While at least one example, non-limiting embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An adapter bulkhead apparatus structurally configured to provide enhanced access to an adapter on an adapter bulkhead comprising:
an adapter holder portion structurally configured to hold an adapter;
a retaining portion structurally configured to movingly retain the adapter holder portion;
a guide portion structurally configured to guide movement of the retaining portion;
wherein the adapter holder portion includes an adapter receiving portion structurally configured to receive an adapter;
wherein the guide portion is structurally configured to include a movement guide portion structurally configured to permit linear movement of the retaining portion relative to the guide portion from a first position to a second position;
wherein the guide portion is structurally configured to include a pivoting guide portion structurally configured to permit the retaining portion to pivot relative to the guide portion at the second position;
wherein the guide portion is structurally configured to prevent pivoting of the retaining portion relative to the guide portion from the first position to a third position that is between the first position and the second position;
wherein the adapter holder portion comprises a plurality of adapter holders that are structurally configured to slide relative to one another and relative to the retaining portion so as to enhance access space to the adapter held by the adapter holder portion; and
wherein the retaining portion is configured to move relative to the guide portion so as to enhance access space to the adapter held by the adapter holder portion.

2. The adapter bulkhead apparatus of claim 1, wherein the guide portion includes a first guide member and a second guide member and comprises a first slot in the first guide member and a second slot in the second guide member structurally configured to retain the retaining portion within the first and second slots while allowing the retaining portion to slide within the first slot and the second slot between the first position and the second position.

3. The adapter bulkhead apparatus of claim 2, wherein the guide portion is structurally configured to selectively retain the retaining portion in the second position.

4. The adapter bulkhead apparatus of claim 1, wherein the guide portion is configured to include a retaining portion rotation prevention portion structurally configured to prevent the retaining portion from rotating when the retaining portion is between the first position and the second position.

5. The adapter bulkhead apparatus of claim 1, wherein the pivoting guide portion is structurally configured to allow the retaining portion to pivot about an axis in a first direction and in a second direction opposite to the first direction when the retaining portion is in the second position.

6. The adapter bulkhead apparatus of claim 5, wherein the pivoting guide portion is structurally configured to prevent the retaining portion from pivoting beyond a preselected pivot range.

7. The adapter bulkhead apparatus of claim 1, wherein the retaining portion is configured to include a first groove and a second groove configured to receive the adapter holder portion.

8. The adapter bulkhead apparatus of claim 1, wherein the adapter holder portions are configured to include a locking portion configured to lock a corresponding one of the adapter holder portions in position.

9. An adapter bulkhead apparatus structurally configured to provide enhanced access to an adapter on an adapter bulkhead comprising:
an adapter holder portion structurally configured to hold an adapter;
a retaining portion structurally configured to movingly retain the adapter holder portion;
a guide portion structurally configured to guide movement of the retaining portion;
wherein the adapter holder portion includes an adapter receiving portion structurally configured to receive an adapter;
wherein the guide portion is structurally configured to include a movement guide portion structurally configured to permit linear movement of the retaining portion relative to the guide portion from a first position to a second position;
wherein the guide portion is structurally configured to prevent pivoting of the retaining portion relative to the guide portion from the first position to a third position that is between the first position and the second position;
wherein the adapter holder portion comprises a plurality of adapter holders that are structurally configured to slide relative to one another and relative to the retaining portion so as to enhance access space to the adapter held by the adapter holder portion; and
wherein the retaining portion is configured to move relative to the guide portion so as to enhance access space to the adapter held by the adapter holder portion.

10. The adapter bulkhead apparatus of claim 9, wherein the guide portion includes a first guide member and a second guide member and comprises a first slot in the first guide member and a second slot in the second guide member structurally configured to retain the retaining portion within the first and second slots while allowing the retaining portion to slide within the first slot and the second slot between the first position and the second position.

11. The adapter bulkhead apparatus of claim 9, wherein the guide portion is structurally configured to selectively retain the retaining portion in the second position.

12. The adapter bulkhead apparatus of claim 9, wherein the guide portion is configured to include a retaining portion rotation prevention portion structurally configured to prevent the retaining portion from rotating when the retaining portion is between the first position and the second position.

13. The adapter bulkhead apparatus of claim 11, wherein the retaining portion includes a panel portion retaining portion structurally configured to retain the panel portions within the retaining portion and to allow the panels to move within the retaining portion.

14. The adapter bulkhead apparatus of claim 9, wherein the retaining portion is configured to include a first groove and a second groove configured to receive the adapter holder portion.

15. The adapter bulkhead apparatus of claim 9, wherein the adapter holder portions are configured to include a locking portion configured to lock a corresponding one of the adapter holder portions in position.

16. The adapter bulkhead apparatus of claim 9, further comprising a pivoting guide portion structurally configured to permit the retaining portion to pivot relative to the guide portion at the second position.

17. The adapter bulkhead apparatus of claim 16, wherein the pivoting guide portion is structurally configured to allow the retaining portion to pivot about an axis in a first direction and in a second direction opposite to the first direction when the retaining portion is in the second position.

18. The adapter bulkhead apparatus of claim 16, wherein the pivoting guide portion is structurally configured to prevent the retaining portion from pivoting beyond a preselected pivot range

19. An adapter bulkhead apparatus structurally configured to provide enhanced access to an adapter on an adapter bulkhead comprising:
an adapter holder portion structurally configured to hold an adapter;
a retaining portion structurally configured to movingly retain the adapter holder portion;
wherein the adapter holder portion includes an adapter receiving portion structurally configured to receive an adapter;
wherein the adapter holder portion comprises a plurality of adapter holders that are structurally configured to slide relative to one another and relative to the retaining portion so as to enhance access space to the adapter held by the adapter holder portion.

20. The adapter bulkhead apparatus of claim 19, wherein the guide portion includes a first guide member and a second guide member and comprises a first slot in the first guide member and a second slot in the second guide member structurally configured to retain the retaining portion within the first and second slots while allowing the retaining portion to slide within the first slot and the second slot.

21. The adapter bulkhead apparatus of claim 19, wherein the guide portion is structurally configured to include a movement guide portion structurally configured to permit linear movement of the retaining portion relative to the guide portion from a first position to a second position

22. The adapter bulkhead apparatus of claim 19, wherein the guide portion is structurally configured to prevent pivoting of the retaining portion relative to the guide portion from the first position to a third position that is between the first position and the second position.

23. The adapter bulkhead apparatus of claim 19, wherein the retaining portion is configured to include a first groove and a second groove configured to receive the adapter holder portion.

24. The adapter bulkhead apparatus of claim 19, wherein the guide portion is structurally configured to include a pivoting guide portion structurally configured to permit the retaining portion to pivot relative to the guide portion.

25. The adapter bulkhead apparatus of claim 19, wherein the guide portion is structurally configured to include a movement guide portion structurally configured to permit linear movement of the retaining portion relative to the guide portion from a first position to a second position.

26. The adapter bulkhead apparatus of claim 19, wherein the adapter holder portions are configured to include a locking portion configured to lock a corresponding one of the adapter holder portions in position.
